(19) United States
(12) Patent Application Publication
(10) Pub. No.: US 2010/0109901 A1
(43) Pub. Date: May 6, 2010

(54) Methods and Systems to Hold Functions on a Device After an Identifier is Determined

(75) Inventors: Gaelle Martin-Cocher, Mississauga (CA); Adrian Buckley, Tracy, CA (US); Jan Hendrik Lucas Bakker, Irving, TX (US)

Correspondence Address: Research in Motion Corp./CR;Attn: J. Robert Brown, 5601 Granite Parkway, Suite 750, Plano, TX, 75024, US

(73) Assignee: Research In Motion Limited, Waterloo (CA)

(21) Appl. No.: 12/536,393

(22) Filed: Aug. 5, 2009

Related U.S. Application Data
(60) Provisional application No. 61/086,408, filed on Aug. 5, 2008.

(51) Int. Cl. G06F 13/42; G06Q 30/00

(52) U.S. Cl. 340/825; 705/14.49; 705/14.58

(57) ABSTRACT

A user agent (UA) is provided. The UA includes a listener component configured to recognize at least one triggering event and, upon recognizing one of the triggering events, to enable a temporary suspension of at least one advertising function on the UA.

### CROSS-REFERENCE TO RELATED APPLICATIONS

The present application claims priority to U.S. Provisional Patent Application No. 61/086,408, filed Aug. 5, 2008, by Gaelle Martin-Cocher, et al, entitled “Methods and Systems to Hold Functions on a Device After an Identifier is Determined” (33891-US-PRV-4214-10100), which is incorporated by reference herein as if reproduced in its entirety.

### BACKGROUND

The IP (Internet Protocol) Multimedia Subsystem (IMS) is a standardized architecture for providing multimedia services and voice-over-IP calls to both mobile and fixed user agents (UAs). The Session Initiation Protocol (SIP) been standardized and governed primarily by the Internet Engineering Task Force (IETF) as a protocol for setting up and managing IMS-based calls. As used herein, the terms “user agent” and “UA” might in some cases refer to mobile devices such as mobile telephones, personal digital assistants, handheld or laptop computers, and similar devices that have telecommunications capabilities. Such a UA might consist of a wireless device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UA might consist of the device itself without such a module. In other cases, the term “UA” might refer to devices that have similar capabilities but that are not transportable, such as fixed line telephones, desktop computers, set-top boxes, or network nodes. When a UA is a network node, the network node could act on behalf of another function such as a wireless device or a fixed line device and simulate or emulate the wireless device or fixed line device. For example, for some wireless devices, the IMS SIP client that would typically reside on the device actually resides in the network and relays SIP message information to the device using optimized protocols. In other words, some functions that were traditionally carried out by a wireless device can be distributed in the form of a remote UA, where the remote UA represents the wireless device in the network. The term “UA” can also refer to any hardware or software component that can terminate a communication session that could include, but is not limited to, a SIP session. Also, the terms “user agent”, “UA”, “user equipment”, “UE”, “wireless device”, and “node” might be used synonymously herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an illustrative network according to an embodiment of the disclosure.

FIG. 2 is a flow diagram illustrating a method for suspending functions on a UA according to an embodiment of the disclosure.

FIG. 3 is a flow diagram illustrating an alternative embodiment of the disclosure.

FIG. 4 is a flow diagram illustrating another alternative embodiment of the disclosure.

FIG. 5 is a flow diagram illustrating still another alternative embodiment of the disclosure.

FIG. 6 is a diagram of a wireless communications system including user equipment operable for some of the various embodiments of the disclosure.

FIG. 7 is a block diagram of user equipment operable for some of the various embodiments of the disclosure.

FIG. 8 is a diagram of a software environment that may be implemented on user equipment operable for some of the various embodiments of the disclosure.

FIG. 9 is an illustrative computing system suitable for some of the various embodiments of the disclosure.

FIG. 10 is a flow diagram illustrating an alternative embodiment of the disclosure.

FIG. 11 is a block diagram of a mobile advertisement system according to an embodiment of the disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In an embodiment, a user agent (UA) is provided. The UA includes a listener component configured to recognize at least one triggering event and, upon recognizing one of the triggering events, to enable a temporary suspension of at least one advertising function on the UA.

In another embodiment, a network component is provided. The network component includes a listener component configured to recognize at least one triggering event and, upon recognizing one of the triggering events, to enable a temporary suspension of at least one advertising function on a user agent, where the user agent could be local to the listener or remote.

Some functions that a UA can perform might have a higher priority than others. For example, a UA with internet connection capabilities might receive multimedia advertisements or ticker-based information such as news feeds and real-time stock prices. From some perspectives, such applications might be considered low-priority functions. High-priority functions might include the core functions of the UA, such as wireless telecommunication functions and operating system functions. As used herein, the term “priority” should not be construed to refer to an unconditional ranking of the importance of all of the functions or applications on a UA. The priorities of the functions or applications might be relative priorities from only a single perspective rather than absolute priorities that take multiple perspectives into account. The priorities of the functions or applications could be defined within the UA or elsewhere.

In an embodiment, low-priority functions on a UA are temporarily suspended when certain triggering events occur. For example, advertisements that are displayed on the screen of the UA or otherwise presented to the UA user might be suspended when an emergency-related call is in progress on the UA. The emergency-related trigger might be an emergency call placed by the UA user, an emergency callback placed to the UA in response to a previous emergency call placed by the UA user, or some other type of call associated with an emergency. An emergency-related call might be placed by the UA user entering an emergency telephone number, such as 911, or entering some other identifier for an emergency service, such as a Uniform Resource Locator (URL), an SOS identifier as described in Internet Engineering Task Force (IETF) Request for Comments (RFC) 5031, or another string of characters that can be used to contact an emergency service. Alternatively, rather than an emergency-related call, the emergency-related trigger might be an indicator from the network that a call was recognized as an emergency call. Any of these types of calls or indicators will be referred to herein as an emergency call.

RFC 5031 identifies different types of emergency calls. In an embodiment, the choice of functions to be suspended can be made dependent on the type of emergency call. Such dependency can be configurable. RFC 5031 also identifies other service calls such as “counseling” services. “Counseling” service calls or callbacks can also be triggering events that cause suspension of functions in various embodiments.

Alternatively, some numbers or identifiers that are not emergency related could also be triggers for suspending a UA function. Such numbers or identifiers could be provisioned or could be defined by a user, a subscriber, or a service provider. For example, a service provider might specify that a given URL of a content provider is such an identifier. When a UA points to this URL, advertising functions on the UA might be suspended.

A listener component residing on the UA or elsewhere might recognize emergency calls and take appropriate actions to suspend advertising-related functions while the emergency call is in progress. For example, the listener might notify an advertising client on the UA, a network node, or some other component about the emergency call, and the notified component might suspend the advertising-related functions. In other embodiments, an event other than an emergency call could act as a trigger, and functions other than advertising-related functions could be suspended when a trigger is recognized.

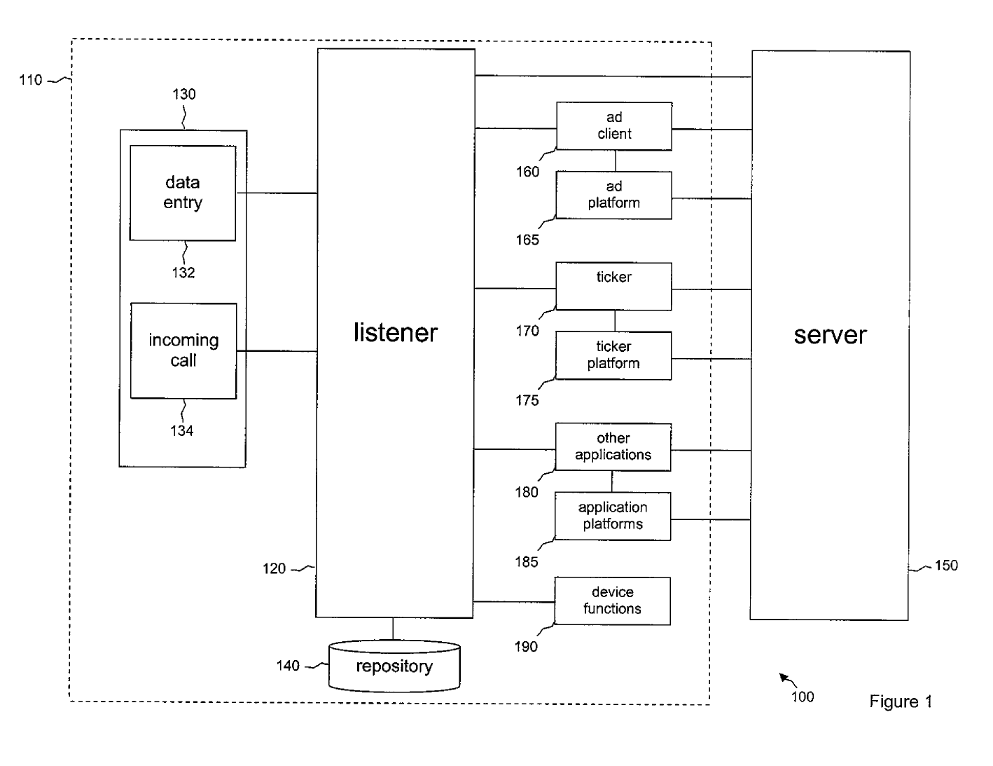

FIG. 1 illustrates a system 100 for suspending functions on a UA 110. The figure is intended to depict several different embodiments in a single drawing. All of the components and connections between components shown in the drawing would not necessarily be present at the same time. Also, other components and connections between components that are not shown might be present in the system 100. The UA 110 might include all of the components within the dashed lines or, as described below, some of these components might reside in a network node or elsewhere in the system 100.

The system 100 includes a listener or group of listener components 120. A listener 120 might be a component within the UA 110 or within a network node, or might be a stand-alone component accessible to the UA 110 and/or a network. A listener 120 might be an application or a component of an application that executes on the UA 110 or might be a generic listener used by several applications or functions on the UA 110. The listener 120 is capable of recognizing trigger events that can lead to the suspension of one or more functions on the UA 110. In some embodiments, when the listener 120 recognizes a trigger 130, the listener 120 directly takes action to suspend one or more functions. Alternatively, when the listener 120 recognizes a trigger 130, the listener 120 can notify another component, perhaps by sending a message and starting a timer associated with that event, and the other component can take appropriate action to suspend one or more functions by receipt of the message. If the timer expires and no response has been received from the function, then provisioned behavior can indicate what the listener is to do. This could include, but is not limited to, resending the message a specified number of times, doing nothing, etc.

In an embodiment, the triggers 130 might be keys, menu items, or other input mechanisms that are activated on the UA 110 or some other type of data entry 132 made into the UA 110. For example, the trigger 130 might be the entry by a UA user of an emergency telephone number, such as 911, or the entry of some other identifier for an emergency service, such as a URL or another string of characters that can be used to contact an emergency service. Alternatively, the trigger 130 could be an event such as, but not limited to, an incoming call 134, such as an emergency callback from an emergency service. In still other embodiments, some other triggers or numbers that are not emergency related could also be monitored and provisioned for the same purpose. Such numbers could be defined by the user, the subscriber, or service provider policies. For example, a given URL to a content provider might be provisioned by the service provider so that there are no advertisements when the user goes to that URL. The trigger 130 could also be the presence of an information element in a message received or even a specific value, alphanumeric string, or setting of a token/flag/code point within an information element.

In an embodiment, a repository 140 of trigger information might be accessible to the listener 120 and/or other components in the system 100. The repository 140 can include a list of triggers 130, a list of functions and/or applications to be suspended and/or notified, and a mapping between the two lists. That is, when a triggering event occurs, the listener 120 or some other component can consult the repository 140 to determine one or more functions and/or applications that are to be suspended and/or notified of the triggering event. The repository 140 can be a component within the UA 110 or within a network node, or might be a stand-alone component accessible to the UA 110 and/or a network.

Data can be provisioned into the repository 140 by various means. For example, the provisioning of the repository 140 can be performed in, but is not limited to, one of the following ways: Open Mobile Alliance (OMA) device management (DM), CP, over-the-air, proprietary, or other. Any of the following transports could be used to provision the repository 140: Cell Broadcast, SMS, USSD, MBMS, Generic IP pipe, or other.

When the repository 140 resides in the UA 110, repository data might be stored in the UA's internal memory or in external, remote, or removable memory. External, remote, or removable memory might be, but is not limited to, PC Card PCMCIA, CompactFlash I CF-I, CompactFlash II CF-II, SmartMedia SM/SMC, Memory Stick MS, Memory Stick Duo MSD, Memory Stick PRO Duo MSPD, Memory Stick PRO-HG Duo MSPDX, Memory Stick Micro M2, Multimedia Card MMC, Multimedia Card RS-MMC, MMCmicro Card MMCmicro, Secure Digital Card SD, SxS SxS, Universal Flash Storage UFS, miniSD Card miniSD, microSD Card microSD, xD-Picture Card xD, Intelligent Stick iStick, Serial Flash Module SFM, μ card μcard, NT Card NT NT+, USIM, R-UIM, etc.

When the listener 120 detects one or more of the triggers 130, the listener 120 could promote the local suspension of one or more of functions and/or applications on the UA 110 by sending a message to the functions and/or applications. Alternatively, the listener 120 could, by sending a message, notify another component, such as a server 150 or an ad client 160, of the trigger detection. In either instance, upon the message being sent, the listener 120 might start a timer (300YYY). If the timer expires, further actions (300ZZZ) might be taken. The other component could then promote the suspension of functions on the UA 110 or a remote function and/or application in the network. Different functions could be suspended based on different triggers 130. While one of the components that might be notified is depicted in FIG. 1 as a server 150, it should be understood that this component could be some other external device or software with which the UA 110 can communicate. This component could also include, but is not limited to, another SIP-related component that could be located on a wireless device.

The embodiment of the message (300XXX) could be, but is not limited to, a message that contains a command such as: Suspend Application, Stop Application, Resume Application, Start Application, Perform Action, etc. In the instance where the message contains the Perform Action command, the message could contain, but is not limited to containing, the trigger itself.

Examples of actions that could be taken when various events occur are included in the following table:

| | | | Action on event |
|---|---|---|---|
| | | Timer value | timer expire |
| Event | Action to take | (300 YYYY) | (300 ZZZZ) |
| Event A | Action A | Timer A | Action A |
| Receive message A | Suspend local | Y seconds | Repeat D timers |
| | function X for | | |
| | time period K | | |
| Receive message A | Inform server | K seconds | Repeat Y timers |
| and information | controlling | | |
| element Y present | function X | | |
| | of event | | |
| Receive message A | Inform server | Z seconds | Do nothing |
| and information | controlling | | |
| element X present | function X of | | |
| | event and to | | |
| | resume service. | | |
| Key stroke Y | | Q seconds | Inform user of error |

An example of a function that could be suspended on the UA 110 when a trigger 130 is detected is an advertising function. In particular, advertising functions might be temporarily suspended when a UA user places an emergency call, when it is recognized that the UA 110 is placing an emergency call, or when an emergency callback is placed to the UA 110. Advertising might be a particularly appropriate function to suspend when an emergency call is made since advertisements can be especially disruptive to a UA user. For example, an advertisement that pops up on the screen of the UA 110 might distract the user from placing or receiving the emergency call. In addition, advertising functions can consume UA resources that might be needed to carry out an emergency call. For example, the UA 110 might include an advertising engine that operates in the background to scan the actions that the user is taking and download advertisements specific to the user's activities. The advertising engine might also cache, select, and present the advertisements. Carrying out these background functions can consume a significant portion of the UA's resources.

In an embodiment, when the listener 120 detects a trigger 130, the listener 120 might notify the advertising client/function/application 160, which might reside on the UA 110, on the server 150, or elsewhere. The advertising client/function/application 160 might then notify an advertising platform 165 that likewise might reside on the UA 110, on the server 150, or elsewhere. The advertising client/function/application 160 or the advertising platform 165 might then take appropriate actions to suspend or stop advertising functions on the UA 110. Alternatively, the advertising client 160 or the advertising platform 165 can send a message to the server 150 that causes the server 150 to suspend any advertising functions that it might direct to the UA 110. Alternatively, upon receiving the message, the server 150 might send another message to the UA 110 that causes the UA 110 to suspend its advertising functions locally. Alternatively, upon receiving the message, the server 150 might send another message to another server to suspend/stop the sending of advertisement information.

In some embodiments, all advertising-related functions are suspended when a trigger 130 is detected. In other embodiments, only advertising-related functions that are resource-intensive or that require user input are suspended. In still other embodiments, only the presentation of advertisements to the UA user is suspended, and background advertising-related functions continue.

In addition to or instead of advertising-related functions, other functions on the UA 110 could be suspended when a trigger 130 is detected. For example, a ticker function 170 such as a news reader application or real-time stock quote application could be suspended. The listener 120 could directly notify the ticker 170 that a trigger 130 was detected and the ticker 170 could notify a ticker platform 175, or the listener 120 could directly notify the ticker platform 175. The ticker 170 and the ticker platform 175 could reside on the UA 110, on the server 150, or elsewhere. The ticker 170 or the ticker platform 175 might suspend ticker-related functions on the UA 110. Alternatively, the ticker 170 or the ticker platform 175 can notify the server 150 of the trigger detection, and the server 150 could suspend any ticker-related functions that it might direct to the UA 110. Alternatively, upon being notified of the trigger detection, the server 150 might send a message to the UA 110 that causes the UA 110 to suspend its ticker-related functions locally.

Other applications 180 or functions 190 on the UA 110 could be suspended when a trigger 130 is detected. The other applications 180 could be supported by appropriate platforms 185. Suspension of the other applications 180 and/or other functions 190 could take place in a manner similar to suspensions of advertisements and tickers described above.

Functions on the UA 110 can be suspended for a specified time period that might be set by policies that reside or are stored on the UA 110, the server 150, or elsewhere. In the case where the trigger 130 is an emergency call, functions might be suspended until the emergency call is complete or for a specified time period after the emergency call is complete. When the suspension period is complete, the UA 110 might take appropriate actions to resume the suspended functions. Alternatively, the server 150 might take actions to resume the suspended functions or might send a message to the UA 110 that causes the UA 110 to resume the suspended functions. Different functions can be resumed at different times.

In the case where the trigger 130 is an emergency call and the suspended functions are advertising-related functions, when the advertisements resume, they can be default advertisements that are not customized for the UA user. As mentioned previously, an advertising engine might record the UA user's actions and present advertisements specific to the user's activities. However, when an emergency call is made, the emergency might take precedence over the user's previous activities, and the presentation of advertisements related to the user's previous activities might be inappropriate. Therefore, the advertisements that are presented when a suspension period ends might be generic advertisements that do not take into account any information gathered by the advertising engine. Alternatively, only the information that can be retrieved from the emergency call, such as the user's current location, but no other personalized information might be taken into account in the selection of the advertisements that are presented when a suspension period ends. Location information might be, but is not limited to, global positioning system coordinates, waypoints, airport codes, city names, addresses, cell identifiers such as cell global identities, network identifiers such as service set identifiers, and so on.

In an embodiment, the number of functions that are suspended when a trigger 130 is detected is related to the battery level of the UA 110. Additional information related to disabling features based on a battery level threshold is available in U.S. patent application Ser. No. 11/872,217, filed on Oct. 15, 2007, entitled “Method and System for Enabling or Disabling Features Based on a Battery Level Threshold”, Gaelle Martin-Cocher et al. inventors, which is incorporated herein by reference for all purposes. That is, when the battery level is near its maximum, only a minimum number of functions are suspended, but as the battery level decreases, more functions might be suspended. For example, when the battery is near full power, only one non-critical function might be suspended when a trigger 130 is detected. Additional non-critical functions, such as advertising-related functions, can be suspended each time the battery power drops below one or more pre-defined levels. The non-critical functions might be prioritized such that lower priority functions are suspended first and higher priority functions are suspended later. In this way, it might be ensured that sufficient battery power is available for critical functions such as an emergency calling capability.

The placing by a user of an emergency call or the receipt by the UA 110 of an emergency callback were mentioned previously as examples of the triggers 130 that could lead to the suspension of functions on the UA 110. However, other events could act as triggers 130. For example, the invoking of a particular service on the UA 110 could be a triggering event. In this case, the trigger 130 could be a service identifier, such as an IMS Communication Service Identifier (ICSI) or an IMS Application Reference Identifier (IARI).

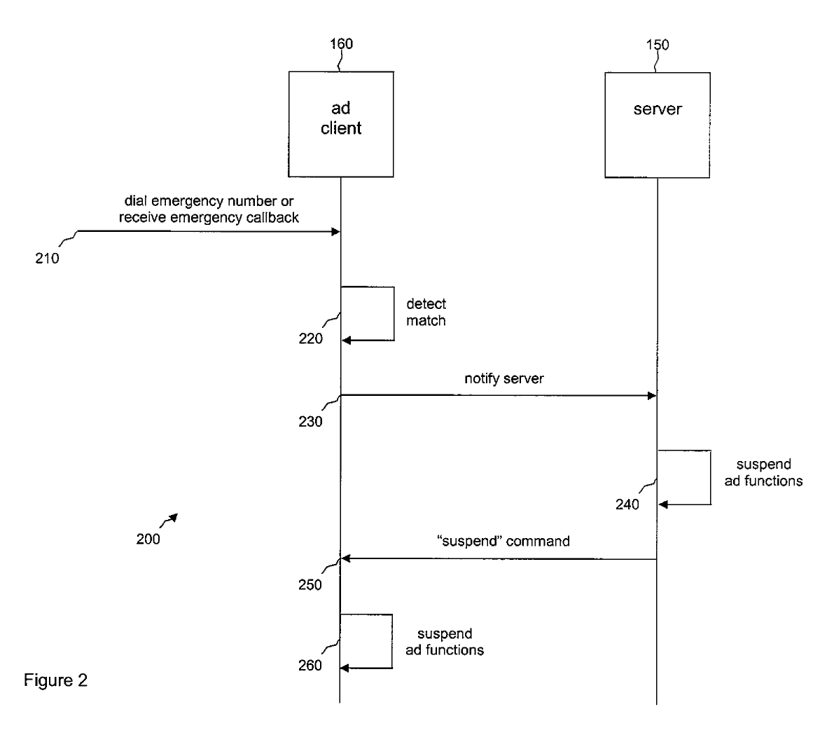

FIG. 2 illustrates an embodiment of a flow diagram 200 for suspending advertisement-related functions on a UA upon recognition of an emergency call. At event 210, an emergency number is dialed, entered, or selected, or an emergency session is originated, or an emergency callback is received. Dialing an emergency number can refer to entering a string of characters into the UA or otherwise entering or selecting information that promotes setting up communication with an emergency service. A listener detects one of these triggering events and informs the ad client 160. At event 220, the listener (or the ad client 160) detects a match between the triggering event and an item in a list of triggering events that can lead to a suspension of a function on a UA. At event 230, the ad client 160 notifies the server 150 that a triggering event has occurred. At event 240, the server 150 suspends its advertising-related functions that are applicable to the UA. At event 250, the server 150 sends a “suspend” command to the ad client 160 informing the ad client 160 to suspend the ad client's advertising-related functions that are applicable to the UA. At event 260, the ad client 160 suspends its advertising-related functions.

In an alternative embodiment, events 230, 240, and 250 might not occur. In this case, when the ad client 160, at event 220, detects a match between the triggering event and the item in the list of triggering events, the ad client 160 can take appropriate actions locally to suspend advertising-related functions on the UA, as shown at event 260. Alternatively, the local suspension can be done prior to the notification to the server or in parallel.

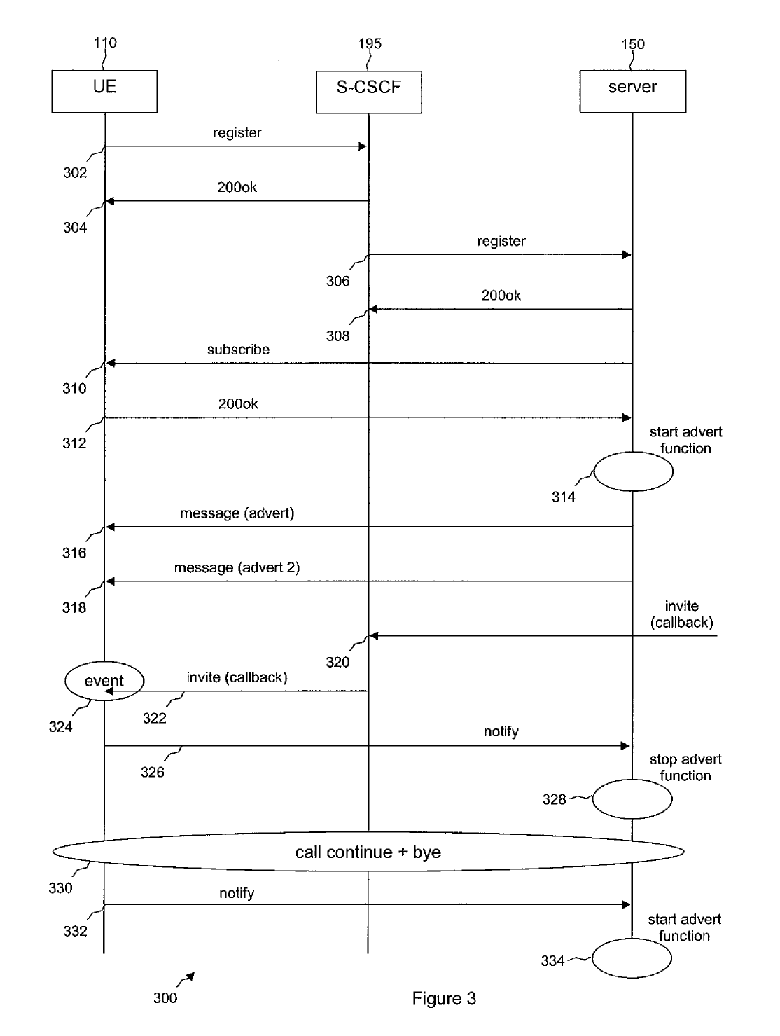

Additional SIP-based embodiments where an emergency callback arrives are illustrated in FIGS. 3, 4, and 5. FIG. 3 illustrates an embodiment where the listener is in the UA 110 and the UA 110 notifies the server 150 to stop pushing advertisements. At event 302, the UA 110 sends a register message to the S-CSCF 195. At event 304, the S-CSCF 195 responds with a 200OK message. At event 306, the S-CSCF 195 sends a register message to the server 150. At event 308, the server 150 responds with a 200OK message. At event 310, the server 150 sends a subscribe message to the UA 110. At event 312, the UA 110 responds with a 200OK message.

At this point, the server 150 can start an advertising function that provides advertisements to the UA 110, as shown at event 314. At events 316 and 318, the server 150 sends advertising messages to the UA 110. At event 320, the S-CSCF 195 receives an invite message in the form of an emergency callback. At event 322, the S-CSCF 195 sends the emergency callback invite message to the UA 110. The UA 110 recognizes the emergency callback as a triggering event at event 324. The recognition of the emergency callback as a triggering event causes the UA 110, at event 326, to send a notify message to the server 150 informing the server 150 to temporarily suspend any advertising functions that are directed to the UA 110. At event 328, the server 150 stops the advertising functions. At event 330, the emergency callback activities between the UA 110, the S-CSCF 195, and the server 150 continue and then complete without any disruptions from advertisements. Upon completion of the emergency callback, the UA 110, at event 332, sends a notify message to the server 150 informing the server 150 that advertising functions can resume. At event 334, the server 150 again starts advertising functions that are directed to the UA 110.

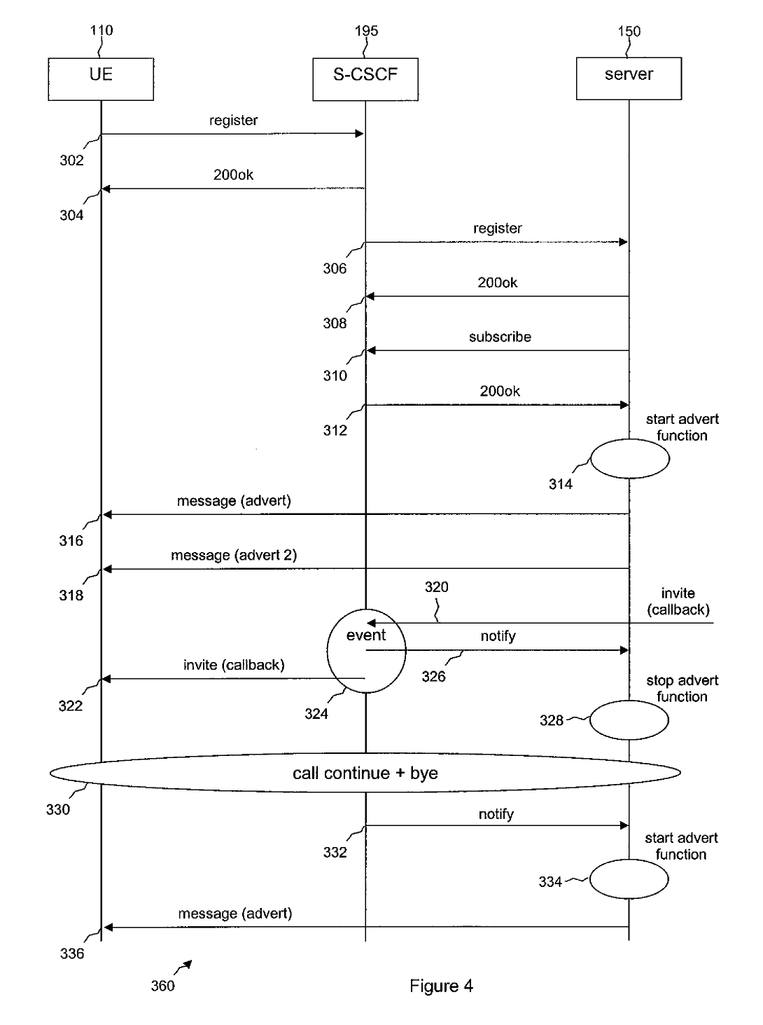

FIG. 4 illustrates an embodiment where the listener in the S-CSCF performs the notification to stop pushing advertisements. Events 302 through 320 occur in a similar manner to the equivalent events in FIG. 3, except that, at events 310 and 312, the subscribe and 200OK messages are exchanged between the server 150 and the S-CSCF 195 rather than between the server 150 and the UA 110. Upon receiving the emergency callback invite message at event 320, the S-CSCF 195 recognizes the callback as a triggering event 324. At event 326, the S-CSCF 195 sends a notify message to the server 150 informing the server 150 to temporarily suspend any advertising functions that are directed to the UA 110. The S-CSCF 195 also sends the callback to the UA 110 at event 322. Events 328 through 332 then occur in a similar manner to the equivalent events in FIG. 3. The server 150 sends an advertising message to the UA 110 at event 336.

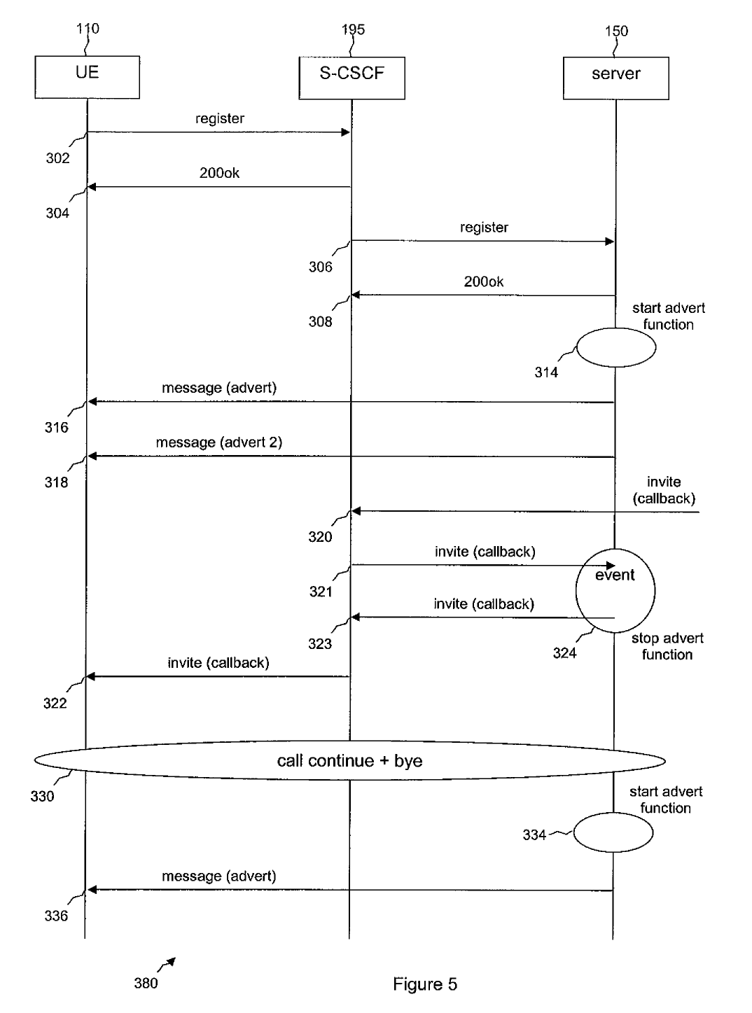

FIG. 5 illustrates an embodiment where the listener is co-located with the advertisement function. That is, the server 150 that controls the advertising functions that are directed to the UA 110 also includes the listener that can recognize triggering events. In this case, when the S-CSCF 195 receives the emergency callback invite message at event 320, the S-CSCF 195 sends the invite message to server 150. The server 150 recognizes the emergency callback as a triggering event 324 and stops the advertising functions that are directed to the UA 110. Subsequent events then occur as described above.

In some embodiments, a network component may be provided that includes a listener component that is configured to recognize at least one triggering event and, upon recognizing one of the triggering events, to promote a temporary suspension of at least one advertising function on a user agent (UA).

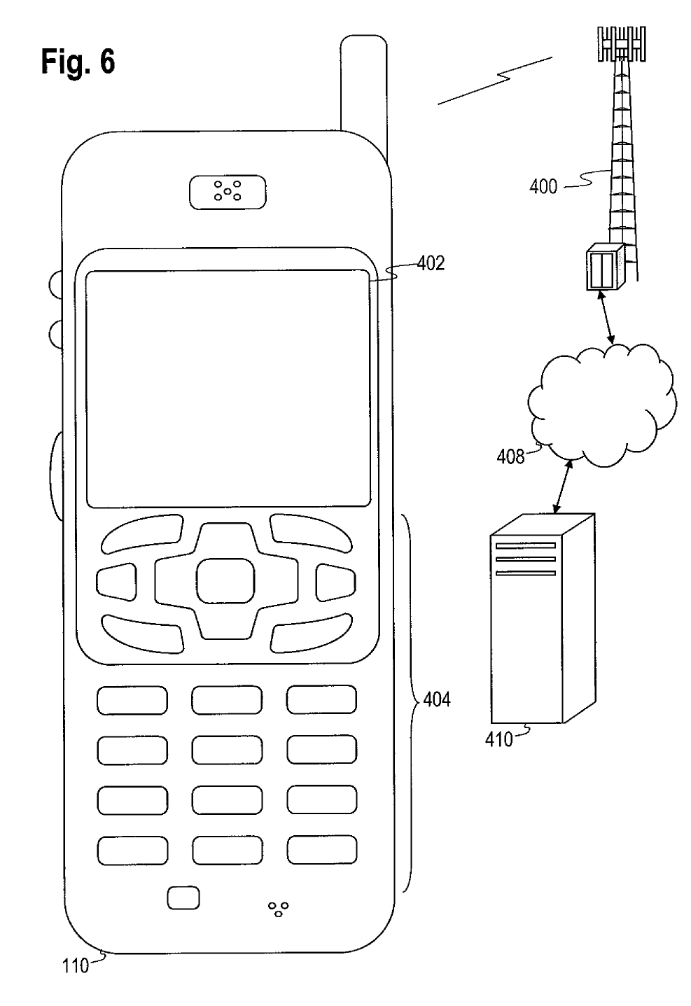

FIG. 6 illustrates a wireless communications system including an embodiment of the UA 110. The UA 110 is operable for implementing aspects of the disclosure, but the disclosure should not be limited to these implementations. Though illustrated as a mobile phone, the UA 110 may take various forms including a wireless handset, a pager, a personal digital assistant (PDA), a portable computer, a tablet computer, or a laptop computer. Many suitable devices combine some or all of these functions. In some embodiments of the disclosure, the UA 110 is not a general purpose computing device like a portable, laptop or tablet computer, but rather is a special-purpose communications device such as a mobile phone, wireless handset, pager, or PDA. In another embodiment, the UA 110 may be a portable, laptop or other computing device. The UA 110 may support specialized activities such as gaming, inventory control, job control, and/or task management functions, and so on.

The UA 110 includes a display 402. The UA 110 also includes a touch-sensitive surface, a keyboard or other input keys generally referred as 404 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a trackwheel, an exit or escape key, a trackball, and other navigational or functional keys, which may be inwardly depressed to provide further input function. The UA 110 may present options for the user to select, controls for the user to actuate, and/or cursors or other indicators for the user to direct. The UA 110 may further accept data entry from the user, including numbers to dial or various parameter values for configuring the operation of the UA 110. The UA 110 may further execute one or more software or firmware applications in response to user commands. These applications may configure the UA 110 to perform various customized functions in response to user interaction. Additionally, the UA 110 may be programmed and/or configured over-the-air, for example from a wireless base station, a wireless access point, or a peer UA 110.

Among the various applications executable by the UA 110 are a web browser, which enables the display 402 to show a web page. The web page may be obtained via wireless communications with a wireless network access node, a cell tower, a peer UA 110, or any other wireless communication network or system 400. The network 400 is coupled to a wired network 408, such as the Internet. Via the wireless link and the wired network, the UA 110 has access to information on various servers, such as a server 410. The server 410 may provide content that may be shown on the display 402. Alternately, the UA 110 may access the network 400 through a peer UA 110 acting as an intermediary, in a relay type or hop type of connection.

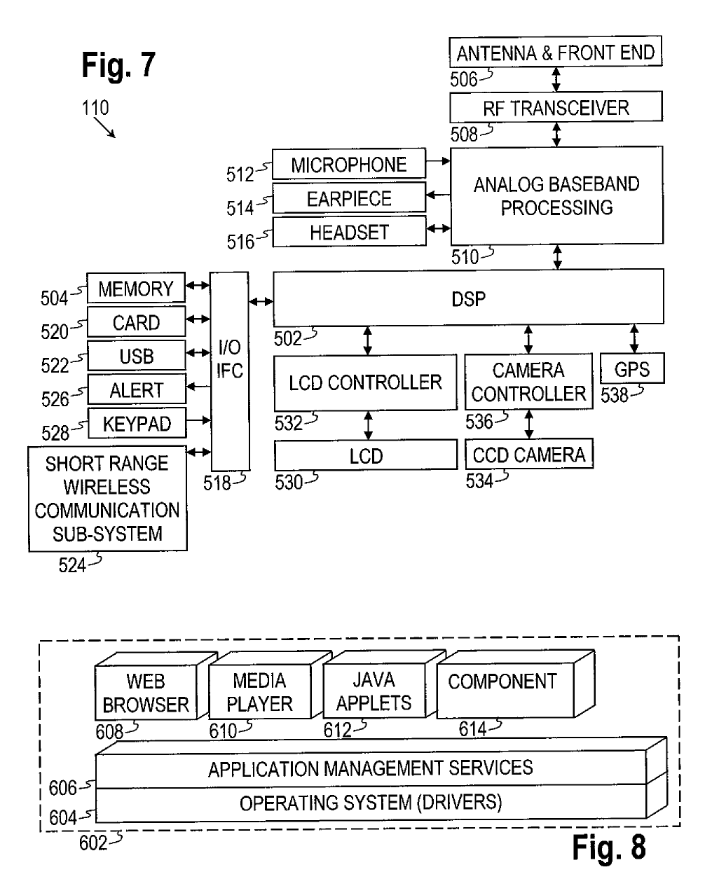

FIG. 7 shows a block diagram of the UA 110. While a variety of known components of UAs 110 are depicted, in an embodiment a subset of the listed components and/or additional components not listed may be included in the UA 110. The UA 110 includes a digital signal processor (DSP) 502 and a memory 504. As shown, the UA 110 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, a short range wireless communication sub-system 524, an alert 526, a keypad 528, a liquid crystal display (LCD), which may include a touch sensitive surface 530, an LCD controller 532, a charge-coupled device (CCD) camera 534, a camera controller 536, and a global positioning system (GPS) sensor 538. In an embodiment, the UA 110 may include another kind of display that does not provide a touch sensitive screen. In an embodiment, the DSP 502 may communicate directly with the memory 504 without passing through the input/output interface 518.

The DSP 502 or some other form of controller or central processing unit operates to control the various components of the UA 110 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the UA 110 to send and receive information from a cellular network or some other available wireless communications network or from a peer UA 110. In an embodiment, the antenna and front end unit 506 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 506 may include antenna tuning and/or impedance matching components, RF power amplifiers, and/or low noise amplifiers.

The RF transceiver 508 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 510 and/or the DSP 502 or other central processing unit. In some embodiments, the RF Transceiver 508, portions of the Antenna and Front End 506, and the analog baseband processing unit 510 may be combined in one or more processing units and/or application specific integrated circuits (ASICs).

The analog baseband processing unit 510 may provide various analog processing of inputs and outputs, for example analog processing of inputs from the microphone 512 and the headset 516 and outputs to the earpiece 514 and the headset 516. To that end, the analog baseband processing unit 510 may have ports for connecting to the built-in microphone 512 and the earpiece speaker 514 that enable the UA 110 to be used as a cell phone. The analog baseband processing unit 510 may further include a port for connecting to a headset or other hands-free microphone and speaker configuration. The analog baseband processing unit 510 may provide digital-to-analog conversion in one signal direction and analog-to-digital conversion in the opposing signal direction. In some embodiments, at least some of the functionality of the analog baseband processing unit 510 may be provided by digital processing components, for example by the DSP 502 or by other central processing units.

The DSP 502 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 502 may perform modulation, coding, interleaving, and spreading, and for a receiver function the DSP 502 may perform despreading, deinterleaving, decoding, and demodulation. In another embodiment, for example in an orthogonal frequency division multiplex access (OFDMA) technology application, for the transmitter function the DSP 502 may perform modulation, coding, interleaving, inverse fast Fourier transforming, and cyclic prefix appending, and for a receiver function the DSP 502 may perform cyclic prefix removal, fast Fourier transforming, deinterleaving, decoding, and demodulation. In other wireless technology applications, yet other signal processing functions and combinations of signal processing functions may be performed by the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the short range wireless communication sub-system 524. The USB interface 522 may be used to charge the UA 110 and may also enable the UA 110 to function as a peripheral device to exchange information with a personal computer or other computer system. The short range wireless communication sub-system 524 may include an infrared port, a Bluetooth interface, an IEEE 802.11 compliant wireless interface, or any other short range wireless communication sub-system, which may enable the UA 110 to communicate wirelessly with other nearby UAs and/or wireless base stations.

The input/output interface 518 may further connect the DSP 502 to the alert 526 that, when triggered, causes the UA 110 to provide a notice to the user, for example, by ringing, playing a melody, or vibrating. The alert 526 may serve as a mechanism for alerting the user to any of various events such as an incoming call, a new text message, and an appointment reminder by silently vibrating, or by playing a specific pre-assigned melody for a particular caller.

The keypad 528 couples to the DSP 502 via the interface 518 to provide one mechanism for the user to make selections, enter information, and otherwise provide input to the UA 110. The keyboard 528 may be a full or reduced alphanumeric keyboard such as QWERTY, Dvorak, AZERTY and sequential types, or a traditional numeric keypad with alphabet letters associated with a telephone keypad. The input keys may include a trackwheel, an exit or escape key, a trackball, and other navigational or functional keys, which may be inwardly depressed to provide further input function. Another input mechanism may be the LCD 530, which may include touch screen capability and also display text and/or graphics to the user. The LCD controller 532 couples the DSP 502 to the LCD 530.

The CCD camera 534, if equipped, enables the UA 110 to take digital pictures. The DSP 502 communicates with the CCD camera 534 via the camera controller 536. In another embodiment, a camera operating according to a technology other than Charge Coupled Device cameras may be employed. The GPS sensor 538 is coupled to the DSP 502 to decode global positioning system signals, thereby enabling the UA 110 to determine its position. Various other peripherals may also be included to provide additional functions, e.g., radio and television reception.

FIG. 8 illustrates a software environment 602 that may be implemented by the DSP 502. The DSP 502 executes operating system drivers 604 that provide a platform from which the rest of the software operates. The operating system drivers 604 provide drivers for the node hardware with standardized interfaces that are accessible to application software. The operating system drivers 604 include application management services (“AMS”) 606 that transfer control between applications running on the UA 110. Also shown in FIG. 8 are a web browser application 608, a media player application 610, and Java applets 612. The web browser application 608 configures the UA 110 to operate as a web browser, allowing a user to enter information into forms and select links to retrieve and view web pages. The media player application 610 configures the UA 110 to retrieve and play audio or audiovisual media. The Java applets 612 configure the UA 110 to provide games, utilities, and other functionality. A component 614 might provide functionality related to suspension of functions on the UA 110.

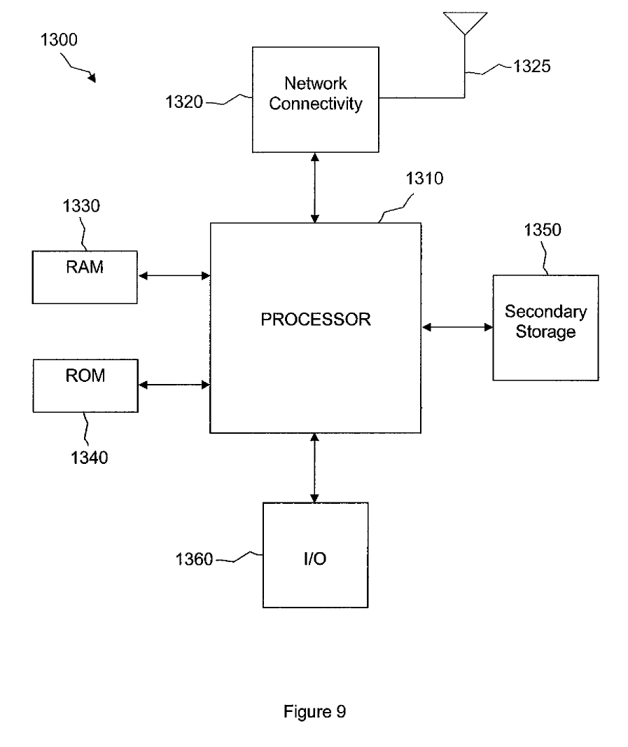

The UA 110 and other components described above might include a processing component that is capable of executing instructions related to the actions described above. FIG. 9 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one processor 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) and/or global system for mobile communications (GSM) radio transceiver devices, and other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 1325 might be considered to be a component of the I/O devices 1360 instead of or in addition to being a component of the network connectivity devices 1320. Some or all of the I/O devices 1360 may be substantially similar to various components depicted in the previously described drawing of the UA 110, such as the display 402 and the input 404.

The following Open Mobile Alliance (OMA) document is incorporated herein by reference: MobAd-AD-1_{—}0. The following 3^{rd} Generation Partnership Project (3GPP) Technical Specification (TS) is also incorporated herein by reference: 3GPP TS 23.141, Presence Service; Architecture and Functional Description; Stage 2, which can be found at: http://www.3gpp.org/ftp/specs/html-info/23141.htm.

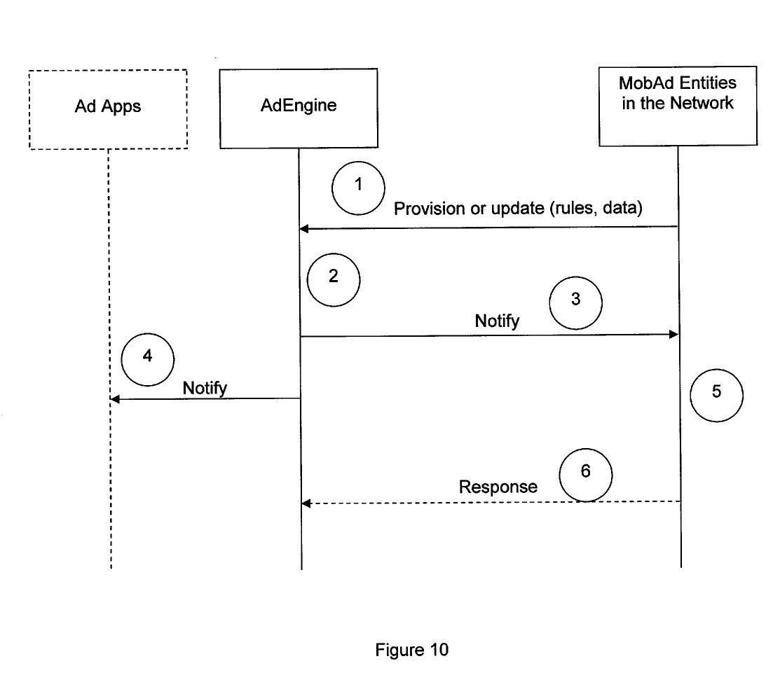

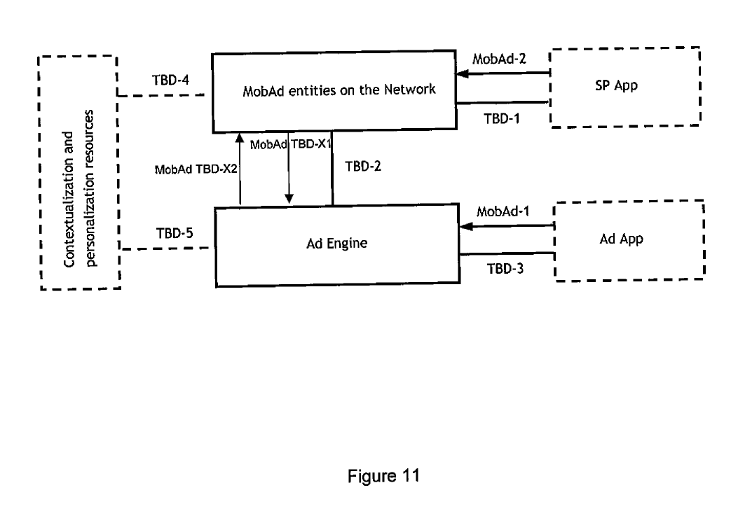

The following describes additional embodiments that include proposed changes to the OMA MobAd-AD-1_{—}0. The message flow diagram of FIG. 10 relates to provisioning the Ad Engine with information for performing its functions and to suspend and resume advertising functions after critical events or conditions are met. Critical events or conditions can be device/network resources threshold, opt-in/opt-out, emergency situation, roaming etc. At event 1, MobAd Entities on the Network provision the Ad Engine with rules, threshold values, and/or identifiers to configure the Ad Engine. The MobAd Entities on the Network can be considered an Ad Server and hereinafter will be referred to as the Ad Server. The rules may comply with various service provider policies. At event 2, the Ad Engine detects a critical event. The critical event might be a resource threshold being met (such as a threshold for a device battery or a network bandwidth), a particular condition being met (such as roaming), an identifier being used (such as a given content provider URL being requested), an emergency identifier being used (such as an identifier related to an emergency call), or an opt-in/opt-out choice being made. At event 3, the Ad Engine may hold part or all of its functions for a given period of time or until the Ad Server sends a command to suspend/resume the functions. At event 4, the Ad Engine may notify the Ad Server of the critical events and/or may notify AdApps. At event 5, the Ad Server processes the notification. At event 6, the Ad Server may modify its functions and may send a response/command to the Ad Engine. The response command may be a Suspend/resume message, a Hold message, or an Opt-in/out message.

FIG. 11 illustrates an embodiment of a modification that might be made to the interfaces of the Ad Engine and of the Ad Server (referred to in the drawing as MobAd Entities on the Network). TBD-1 represents a collection of all interfaces between the Ad Server and an SP App. TBD-2 represents a collection of all interfaces between the Ad Server and the Ad Engine. TBD-X1 is an interface exposed by the Ad Engine to the Ad Server. It is used by the Ad Server to provide the Ad Engine with rules and various data (such as threshold values, a list of identifiers, and/or keywords) that will be necessary for the Ad Engine to perform its function. The TBD-X1 interface is also used to update already provided rules, identifiers, and data and/or to send commands to the Ad Engine, such as opt-in/opt-out, suspend, and resume. TBD-X2 is an interface exposed by the Ad Server to the Ad Engine. It is used by the Ad Engine to notify the Ad Server when a given set of rules, triggers, and/or thresholds are met (for example: opt-in/out, threshold is met, events of interest have occurred). Other messages may be exchanges over TBD-X1 and TBD-X2 such as Ad request and Ad response as well as metrics reports. TBD-3 represents a collection of all interfaces between the Ad Engine and an Ad App. TBD-4 represents a collection of all interfaces between C&PR and the Ad Server. TBD-5 represents a collection of all interfaces between C&PR and the Ad Engine. TBD-4 and TBD-5 could be either the same or different interfaces.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A user agent (UA), comprising:
a listener component configured to recognize at least one triggering event and, upon recognizing one of the triggering events, to enable a temporary suspension of at least one advertising function on the UA.

2. The UA of claim 1, wherein the triggering event comprises at least one of:
an entry of emergency-related data into the UA; and
a reception of emergency-related data by the UA.

3. The UA of claim 1, wherein the enabling of the temporary suspension comprises at least one of:
the listener component suspending the at least one advertising function;
the listener component notifying an advertising client of the triggering event and the advertising client suspending the at least one advertising function;
the listener component notifying an advertising client of the triggering event, the advertising client notifying an advertising platform of the triggering event, and the advertising platform suspending the at least one advertising function;
the listener component notifying a network component of the triggering event and the network component suspending the at least one advertising function;
the listener component notifying a network component of the triggering event and the network component enabling the UA suspending the at least one advertising function;
the listener component notifying a network component of the triggering event and the network component enabling the advertising client suspending the at least one advertising function; and
the listener component notifying a network component of the triggering event and the network component enabling the advertising platform suspending the at least one advertising function.

4. The UA of claim 1, wherein the advertising function is at least one of:
displaying a visible image related to an advertisement;
playing an audible sound related to an advertisement;
displaying text related to an advertisement;
collecting user data for use in providing an advertisement on the UA; and
analyzing user data for use in providing an advertisement on the UA.

5. The UA of claim 4, wherein the visible image includes at least one of:
a still image;
a video;
an audio; and
an audio/video.

6. The UA of claim 1, wherein the temporary suspension occurs upon a detection of a match between the at least one triggering event and an item in a repository of triggering events that are mapped to one or more functions that are to be temporarily suspended when the match is detected.

7. The UA of claim 1, wherein a duration of the temporary suspension is one of:
a duration of an emergency call;
a duration of an emergency call plus an additional amount of time;
a duration defined by service provider policies.

8. The UA of claim 7, wherein an advertisement presented at an end of the duration of the temporary suspension is not customized for a user of the UA.

9. The UA of claim 7, wherein an advertisement presented at the end of the duration of the temporary suspension is customized according to information retrieved from the emergency session.

10. The UA of claim 9, wherein the information retrieved from the emergency session is a location.

11. The UA of claim 1, wherein a plurality of functions on the UA are temporarily suspended, and wherein a number of functions on the UA that are temporarily suspended increases when a level of battery power on the UA falls below a predefined level.

12. The UA of claim 11, wherein at least one relatively lower priority function is temporarily suspended when the level of battery power on the UA is relatively higher, and at least one relatively higher priority function is temporarily suspended when the level of battery power on the UA is relatively lower.

13. The UA of claim 1, wherein the suspended advertising function is local to the listener.

14. The UA of claim 1, wherein the suspended advertising function is remote from the listener.

15. The UA of claim 1, wherein the listener enables the temporary suspension of at least one advertising function on the UA by sending a message related to the advertising function, the message containing a command indicating at least one of:
event occurred;
suspend application;
stop application;
resume application;
start application; and
perform action.

16. The UA of claim 15, wherein, when the message is of type “event occurred”, the message contains information related to the triggering event.

17. The UA of claim 1, wherein the triggering event comprises at least one of
detection of an identifier which was provisioned to the UA; and
detection of an identifier defined by a user.

18. The UA of claim 1, wherein the UA receives information related to the at least one triggering event by receiving at least one of:
a rule from a network component;
a dedicated message from a network component;
a device management message;
a user input; and
a setting of the UA.

19. The UA of claim 18, wherein the UA receives information related to the at least one triggering event at a provisioning step.

20. The UA of claim 17, wherein the UA receives information related to the identifier by receiving at least one of:
a rule from a network component;
a dedicated message from a network component;
a device management message;
a user input; and
a setting of the UA.

21. The UA of claim 20, wherein the UA receives information related to the at least one triggering event at a provisioning step.

22. The UA of claim 1, wherein the UA receives at least one rule applying to at least one of the triggering events, and wherein the at least one rule defines at least one of:
a temporary suspension of at least one advertising function on the UA;
a temporary suspension of an optional function on the UA;
a duration of the suspension;
a type of message and information to be provided to a network component at resumption of a function; and
a type of advertisement to be used at resumption of a function.

23. The UA of claim 17, wherein the UA receives at least one rule applying to at least one identifier, and wherein the at least one rule defines at least one of:
a temporary suspension of at least one advertising function on the UA;
a temporary suspension of an optional function on the UA;
a duration of the suspension;
a type of message and information to be provided to a network component at resumption of a function; and
a type of advertisement to be used at resumption of a function.

24. A network component, comprising:
a listener component configured to recognize at least one triggering event and, upon recognizing one of the triggering events, to enable a temporary suspension of at least one advertising function on a user agent (UA).

25. The network component of claim 24, wherein the triggering event comprises at least one of:
an entry of emergency-related data into the UA; and
a reception of emergency-related data by the UA.

26. The network component of claim 24, wherein the enabling of the temporary suspension comprises at least one of:
the listener component notifying the UA of the triggering event and the UA suspending the at least one advertising function;
the listener component notifying an advertising client of the triggering event and the advertising client suspending the at least one advertising function; and
the listener component notifying an advertising platform of the triggering event and the advertising platform suspending the at least one advertising function.

27. The network component of claim 24, wherein the advertising function is at least one of:
displaying a visible image related to an advertisement;
playing an audible sound related to an advertisement;
displaying text related to an advertisement;
collecting user data for use in providing an advertisement on the UA; and
analyzing user data for use in providing an advertisement on the UA.

28. The network component of claim 27, wherein the visible image includes at least one of:
a still image;
a video;
an audio; and
an audio/video.

29. The network component of claim 24, wherein the temporary suspension occurs upon a detection of a match between the at least one triggering event and an item in a repository of triggering events that are mapped to one or more functions that are to be temporarily suspended when the match is detected.

30. The network component of claim 24, wherein a plurality of functions on the UA are temporarily suspended, and wherein a number of functions on the UA that are temporarily suspended increases when a level of battery power on the UA falls below a predefined level.
